(19) United States
(12) Patent Application Publication
(10) Pub. No.: US 2005/0085363 A1
(43) Pub. Date: Apr. 21, 2005

(54) Welded multi-chamber tube

(75) Inventors: Werner Helms, Esslingen (DE); Volker Kurz, Stuttgart (DE)

Correspondence Address: FOLEY AND LARDNER;SUITE 500, 3000 K STREET NW, WASHINGTON, DC, 20007, US

(73) Assignee: BEHR Gmbh & CO. KG

(21) Appl. No.: 10/501,811

(22) PCT Filed: Jan. 16, 2003
(86) PCT No.: PCT/EP03/00403

(30) Foreign Application Priority Data
Jan. 17, 2002 (DE) R102 01 511.2

(51) Int. Cl. B31B 1/00

(52) U.S. Cl. 493/51

(57) ABSTRACT

The invention relates to a multi-chamber tube (1) produced from a flat strip (2) by welding along the longitudinal face, comprising two planar side faces (10, 11), two curved narrow edges (12, 13) and folded webs (7, 8, 9), made from the flat strip (2) which divide adjacent chambers (3, 4, 5, 6) and which are soldered to the inner wall of the tube (11′). According to the invention, the webs (7, 8, 9) are formed from only one side face (10) of the multi-chamber tube (1) and the other side face (11) has an essentially flat embodiment.

The invention relates to a multi-chamber flat tube which is manufactured from a flat strip and is welded longitudinally, according to the preamble of patent claim 1. Such a multi-chamber flat tube has been disclosed by EP-A 0 457 470.

The known flat tube is manufactured from a strip of sheet metal or a flat strip, beads being initially impressed in the flat strip, specifically over its entire width, i.e. in both halves of the flat strip. The beads are then shaped into folded webs so that the two limbs of the webs bear closely one against the other. The tube is then folded approximately in the center so that the two halves of the strip come to bear against one another, the webs being arranged offset with respect to one another. The longitudinal edges of the two halves of the strip which abut one another are then welded to one another by means of a longitudinal seam so that a closed cross section is produced. Finally, the tube whose strip material is solder plated is soldered so that the backs of the webs form a soldered connection to the wall of the tube located opposite. So-called corrugated fins, which are soldered to the flat tubes and thus form the latticework of a heat exchanger, are arranged on the outside of the flat tubes.

In a further embodiment of EP-A 0 457 470, the webs are not offset with respect to one another but instead arranged opposite one another, but they extend only over half of the tube thickness and abut one another in the center. The folding of the webs from the two strip halves or the two longitudinal faces gives rise to tolerance problems during the manufacturing process, which can have an unfavorable influence on, inter alia, the position of the welding seam.

The object of the present invention is therefore to improve the generic multi-chamber tube to the effect that, while having a small wall thickness and sufficient stability under pressure, it can be manufactured reliably in terms of processes, i.e. in particular with respect to the soldering process and the welding process.

This object is achieved for the generic multi-chamber flat tube by means of the characterizing features of patent claim 1. The material is shaped into beads or folded webs only on one half of the flat strip, while the other half of the flat strip remains smooth. This results in improved position control and shaping capability of the beads, and moreover also in improved control of the position of the weld seam in the region of the narrow face of the flat tube. The shape of the tube and the position of the weld seam can be satisfactorily controlled during the welding process, which increases the reliability of the process when manufacturing the tube.

According to one advantageous development of the invention, the position of the welding seam in the region of the narrow face is variable, i.e. it can either be arranged above the apex point of the curvature or below the apex point. As a result the welding process can be better controlled.

According to one advantageous development of the invention, the wall thickness of this multi-chamber flat tube can be reduced to less than 0.25 mm, which means, on the one hand, a saving in costs and, on the other hand, an increase in performance for the heat exchanger which is equipped with this tube.

According to one advantageous development, the thickness of this flat tube is less than 2 mm, which means a considerably low drop in pressure on the air side, that is to say the outside, of this tube. Such a tube can advantageously be used, for example, for an air-cooled, single-row coolant radiator for motor vehicles.

According to a further refinement of the invention, this tube is suitable in particular for asymmetrical widening of the tube end, which is not readily possible with the conventional folded tubes.

An exemplary embodiment of the invention is illustrated in the drawing and will be described in more detail below. In the drawing:

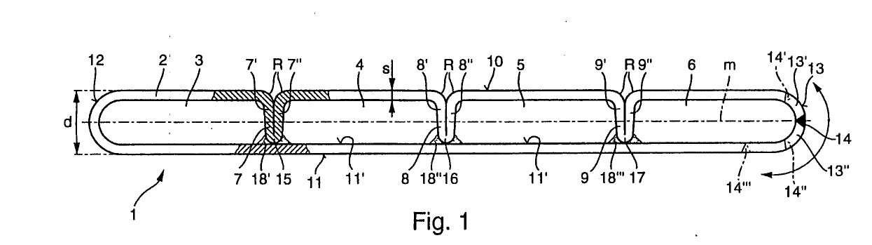

FIG. 1 shows a multi-chamber flat tube in cross section,

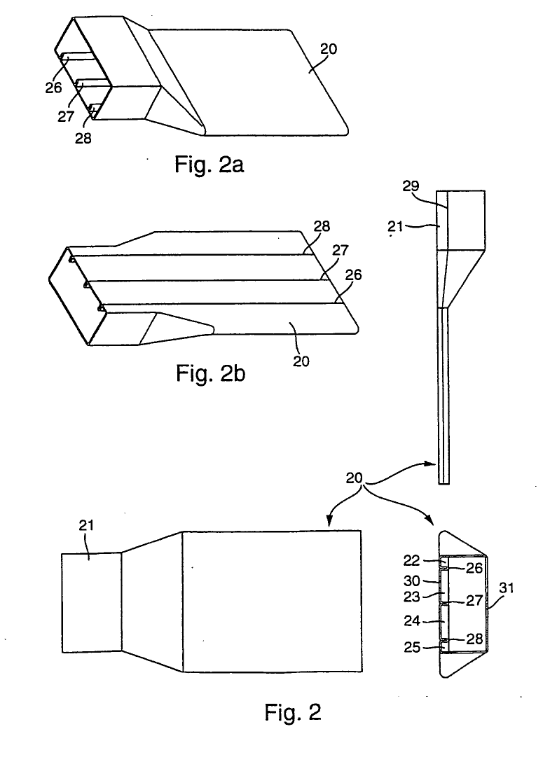

FIG. 2 shows an asymmetrically widened tube end of a multi-chamber flat tube, and

FIGS. 2a, 2b show a perspective view of the multi-chamber flat tube according to FIG. 2.

FIG. 1 shows a multi-chamber flat tube 1 in cross section, which tube is manufactured from a flat strip 2. This flat strip is preferably composed of an aluminum alloy which is solder plated on both sides. The multi-chamber tube 1 has four chambers 3, 4, 5, 6 which are divided from one another by three webs 7, 8, 9. The flat tube 1 has an upper longitudinal face 10 and a lower longitudinal face 11 as well as a left-hand curved narrow face 12 and a right-hand narrow face 13 which is also curved. The flat strip 2 has two edges 13′ and 13″ which are butt jointed to one another on the narrow face 13 and connected in a sealed fashion there by means of a longitudinal welding seam 14.

The webs 7, 8, 9 are manufactured by means of a folding process which is known from the prior art, i.e. each web is composed of two limbs 7′, 7″, 8′, 8″, 9′, 9″ as well as of a web back 15, 16, 17 which connects the two limbs. All three webs 7, 8, 9 are folded out of the longitudinal wall 10, i.e. the upper half of the flat strip 2, i.e. they all project from the upper longitudinal wall 10 in the direction of the lower longitudinal wall 11 where their web backs 15, 16, 17 are permanently connected in a sealed fashion to the inner wall 11′ of the lower longitudinal wall 11 by means of a soldered connection 18′, 18″, 18′″. The webs thus fulfill three functions:
1) they absorb the forces resulting from the internal pressure and counteract a deformation of the flat tube (tie rod);
2) they divide the overall cross section of the flat tube into individual chambers (reduction of the hydraulic diameter) and
3) they conduct the heat from the inside to the outside.

The flat strip preferably has a wall thickness of s≈0.25 mm, and the thickness d of the flat tube is d≈1.8 mm. On the outside of the longitudinal side 10, the folded webs result in bending radii R which are however kept as small as possible. Owing to the small wall thickness s, this is relatively possible. As a result, a somewhat smooth surface is produced on the longitudinal face 10 so that an uninterrupted soldered connection to a corrugated fin (not illustrated in the drawing) is also ensured. The gap remaining as a result of the radii R is readily filled with solder during the soldering process.

As already mentioned, the webs are formed only from one half of the flat strip 2, i.e. the other half of the strip remains smooth. Owing to this arrangement of the folded webs on one side, the position of the welding seam is controlled significantly better during the fabrication process and can also vary. The various possible positions of the welding seam 14 are indicated by further welding seams 14′, 14″, 14′″. This is the case if the longitudinal edges 13′, 13″ do not meet precisely at the apex point of the narrow face 13, that is to say on the center line m, during the fabrication process. Correction can then be performed relatively easily by means of the smooth half of the strip, i.e. the longitudinal face 11.

FIG. 2 shows a multi-chamber tube 20 whose tube end 21 is widened asymmetrically, i.e. only on one side. Such an assymetrical widening of the tube end is known from DE-A 198 20 987 of the applicant. This widening of the tube end serves the purpose of soldering the tube ends to one another longitudinally so that it is possible to dispense with a conventional tube base.

The cross section of the multi-chamber tube 20 is shown clearly in the lower plan view: it is composed of four chambers 22, 23, 24, 25 which are divided by three folded webs 26, 27, 28. This multi-chamber tube 20 is, like the exemplary embodiment described above, manufactured from a flat strip and welded by means of a longitudinal seam 29. As a result of the fact that the webs 26, 27, 28 are formed from only one longitudinal face, specifically the left-hand longitudinal face 30, the longitudinal face 31 which is located opposite can easily be shaped in the outward direction, i.e. widened, in the region of the tube end 21. This ensures that the design according to DE-A 198 20 937 can also be applied for multi-chamber tubes, i.e. thin-walled, high-performance tubes.

FIG. 2a and FIG. 2b show perspective views of the multi-chamber flat tube 20 having the webs 26, 27, 28.

1. A multi-chamber tube (1) which is manufactured from a flat strip (2), is welded longitudinally and has two flat longitudinal faces (10, 11) and two curved narrow faces (12, 13), and webs (7, 8, 9) which are folded out of the flat strip (2), divide adjacent chambers (3, 4, 5, 6) and are welded to the inner wall (11′) of the tube, characterized in that the webs (7, 8, 9) are formed from only one longitudinal face (10) of the multi-chamber tube (1), and in that the other longitudinal face (11) has an essentially flat embodiment.

2. The multi-chamber tube as claimed in claim 1, characterized in that a longitudinal welding seam (14), whose position (14′, 14″, 14′″) is variable, is arranged in the region of one narrow face (13).

3. The multi-chamber tube as claimed in claim 1, characterized in that the tube (1) has a wall thickness of s≦0.5 mm, in particular s≦0.25 mm.

4. The multi-chamber tube as claimed in claim 1, characterized in that the tube (1) has a thickness (external dimension) of d≦2.0 mm.

5. The multi-chamber tube as claimed in claim 1, characterized in that the tube (20) is widened asymmetrically at the end (21), the longitudinal face (30) having the folded webs (26, 27, 28) remaining essentially unshaped.

6. The multi-chamber tube as claimed in claim 2, characterized in that the tube (1) has a wall thickness of s≦0.5 mm, in particular s≦0.25 mm.

7. The multi-chamber tube as claimed in claim 2, characterized in that the tube (1) has a thickness (external dimension) of d≦2.0 mm.

8. The multi-chamber tube as claimed in claim 3, characterized in that the tube (1) has a thickness (external dimension) of d≦2.0 mm.

9. The multi-chamber tube as claimed in claim 2, characterized in that the tube (20) is widened asymmetrically at the end (21), the longitudinal face (30) having the folded webs (26, 27, 28) remaining essentially unshaped.

10. The multi-chamber tube as claimed in claim 3, characterized in that the tube (20) is widened asymmetrically at the end (21), the longitudinal face (30) having the folded webs (26, 27, 28) remaining essentially unshaped.

11. The multi-chamber tube as claimed in claim 4, characterized in that the tube (20) is widened asymmetrically at the end (21), the longitudinal face (30) having the folded webs (26, 27, 28) remaining essentially unshaped.
